(19) United States
(12) Patent Application Publication
(10) Pub. No.: US 2020/0243943 A1
(43) Pub. Date: Jul. 30, 2020

(54) ANTENNA DEVICE, COMMUNICATION TERMINAL, AND STEM-WINDING WATCH

(71) Applicant: Murata Manufacturing Co., Ltd., Nagaokakyo-shi (JP)

(72) Inventor: Hironobu TAKAHASHI, Nagaokakyo-shi (JP)

(21) Appl. No.: 16/374,822

(22) Filed: Apr. 4, 2019

Related U.S. Application Data
(63) Continuation of application No. PCT/JP2017/031095, filed on Aug. 30, 2017.

(30) Foreign Application Priority Data
Oct. 14, 2016 (JP) 2016-202156

(51) Int. Cl. H01Q 1/22; H01Q 7/00; G04G 21/04

(52) U.S. Cl. CPC H01Q 1/22; G04G 21/04; H01Q 7/00

(57) ABSTRACT

A wristwatch includes a circuit board, a feeding coil antenna mounted on or in the circuit board, and a ground conductor disposed in or on the circuit board. The ground conductor includes an outer periphery, an opening, and a slit, which connects an inner periphery of the opening and the outer periphery to each other. A connection conductor is disposed on the circuit board to cross over the slit of the ground conductor to connect portions of the ground conductor to each other. The connection conductor defines a portion of a path of current flowing through the ground conductor in a loop.

### CROSS REFERENCE TO RELATED APPLICATIONS

This application claims the benefit of priority to Japanese Patent Application No. 2016-202156 filed on Oct. 14, 2016 and is a Continuation Application of PCT Application No. PCT/JP2017/031095 filed on Aug. 30, 2017. The entire contents of each of these applications are hereby incorporated herein by reference.

### BACKGROUND OF THE INVENTION

### 1. Field of the Invention

The present invention relates to an antenna device including a feeding coil antenna and a planar conductor, a communication terminal including the antenna device, and a stem-winding watch including the antenna device.

### 2. Description of the Related Art

International Publication No. 2012/033031 describes an antenna device that includes a feeding coil antenna and a planar conductor, in which the feeding coil antenna is disposed adjacent to a peripheral portion of the planar conductor. In this antenna device, the feeding coil antenna and the planar conductor are electromagnetically coupled together, current flowing through the feeding coil antenna induces current mainly circling along the peripheral portion of the planar conductor, and current flowing through the planar conductor induces current to the feeding coil antenna. The planar conductor thus functions as a booster antenna.

An antenna device including a feeding coil antenna and a planar conductor may use, as its planar conductor, a conductor originally installed in an electronic device to which the antenna device is assembled. For example, a ground conductor pattern extending in a plane and provided in or on a circuit board accommodated in the housing of the electronic device is usable as a planar conductor of the antenna device.

When the circuit board includes an opening at its center, and a cut portion that connects the inner periphery of the opening and the outer periphery of the circuit board to each other, the ground conductor pattern in or on the circuit board does not effectively function as the above-described booster antenna. This is because the induced current that flows along the outer periphery of the ground conductor pattern and the induced current that flows along the inner periphery of the opening flow in the opposite directions, and thus degrade the function as the booster antenna.

### SUMMARY OF THE INVENTION

Preferred embodiments of the present invention provide antenna devices each including a substrate including a planar conductor and an opening at its center or approximate center, and in which an inner periphery of the opening and an outer periphery of the substrate are connected to each other with a cut portion. The planar conductor defines and functions as a booster antenna. Preferred embodiments of the present invention also provide communication terminals each including an antenna device, and stem-winding watches each including an antenna device.

An antenna device according to a preferred embodiment of the present invention includes a planar conductor, a substrate in or on which the planar conductor is disposed, the substrate have an identical or substantially identical shape as the planar conductor, a feeding coil antenna including a first coil opening end and a second coil opening end, which oppose each other, the feeding coil antenna being mounted on the substrate, and a connection conductor. The planar conductor includes an outer periphery, an opening, an inner periphery defined by the opening, and a cut portion that connects the inner periphery and the outer periphery to each other. The connection conductor crosses the cut portion of the planar conductor to connect portions of the planar conductor to each other, and defines a portion of a path of current flowing through the planar conductor in a loop. The first coil opening end of the feeding coil antenna is located closer to the outer periphery of the planar conductor than to the inner periphery of the opening.

In the above-described structure, a portion of current flowing through the planar conductor that is to flow through the cut portion flows through the connection conductor that crosses over the cut portion, and almost no current flows along the cut portion and the inner periphery of the opening. The planar conductor thus equivalently includes neither an opening nor a cut portion, so that the planar conductor effectively defines and functions as a booster antenna.

Preferably, the connection conductor is a covered wire including a conductor wire covered with an insulator film. Thus, the connection conductor is not electrically connected to the winding stem, and the antenna characteristics are able to be stabilized.

A communication terminal according to a preferred embodiment of the present invention includes an antenna device, an internal device, an external operator, and an operation stem that connects the internal device and the external operator to each other. The antenna device includes a planar conductor, a substrate in or on which the planar conductor is disposed, the substrate having an identical or substantially identical shape as the planar conductor, a feeding coil antenna including a first coil opening end and a second coil opening end, which oppose each other, the feeding coil antenna being mounted on the substrate, and a connection conductor. The planar conductor includes an outer periphery, an opening, an inner periphery defined by the opening, and a cut portion that connects the inner periphery and the outer periphery to each other. The connection conductor crosses the cut portion of the planar conductor to connect portions of the planar conductor to each other, and defines a portion of a path of current flowing through the planar conductor in a loop. The first coil opening end of the feeding coil antenna is located closer to the outer periphery of the planar conductor than to the inner periphery of the opening.

In the above-described structure, the planar conductor disposed in or on the substrate equivalently defines and functions as a current path including neither an opening nor a cut portion, so that the planar conductor effectively defines and functions as a booster antenna. Thus, a small-sized communication terminal including a small-sized substrate is achieved.

Preferably, the connection conductor is a covered wire including a conductor wire covered with an insulator film. Thus, the connection conductor is not electrically connected to the winding stem, and the antenna characteristics are able to be stabilized.

A stem-winding watch according to a preferred embodiment of the present invention includes an antenna device, a watch movement, a crown, a winding stem that connects the watch movement and the crown to each other, and a casing that accommodates the antenna device, the watch movement, and the winding stem. The antenna device includes a planar conductor, a substrate in or on which the planar conductor is disposed, the substrate having an identical or substantially identical shape as the planar conductor, a feeding coil antenna including a first coil opening end and a second coil opening end, which oppose each other, the feeding coil antenna being mounted on the substrate, and a connection conductor. The planar conductor includes an outer periphery, an opening, an inner periphery defined by the opening, and a cut portion that connects the inner periphery and the outer periphery to each other. The connection conductor crosses the cut portion of the planar conductor to connect portions of the planar conductor to each other, and defines a portion of a path of current flowing through the planar conductor in a loop. The first coil opening end of the feeding coil antenna is located closer to the outer periphery of the planar conductor than to the inner periphery of the opening.

In the above-described structure, the planar conductor disposed in or on the substrate equivalently defines and functions as a current path including neither an opening nor a slit, so that the planar conductor effectively defines and functions as a booster antenna. Thus, a stem-winding watch (a wristwatch or a pocket watch) having high antenna characteristics are able to be obtained.

Preferably, the substrate includes a slit located to correspond to the cut portion, and, when viewed in a plan, the watch movement is disposed in the opening, and the winding stem is disposed in the slit. Thus, the watch movement and the substrate are able to be accommodated in the casing having a limited thickness, without the thickness of the substrate being added to the thickness of the watch movement.

Preferably, the connection conductor crosses over the winding stem in the slit. The connection conductor is able to bridge the slit of the planar conductor with a short path length without causing the winding stem and the connection conductor to interfere with each other.

Preferably, the connection conductor is a covered wire including a conductor wire covered with an insulator film. Thus, the connection conductor is not electrically connected to the winding stem, and the antenna characteristics are able to be stabilized.

Preferred embodiments of the present invention provide antenna devices each including a substrate including a planar conductor and an opening at its center or approximate center, and in which an inner periphery of the opening and an outer periphery of the substrate are connected to each other with a cut portion. The planar conductor defines and functions as a booster antenna. Preferred embodiments of the present invention also provide communication terminals each including an antenna device, and stem-winding watches each including an antenna device.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of a main portion of a wristwatch 101 according to a first preferred embodiment of the present invention, and FIG. 1B is a bottom view of the main portion.

FIG. 2A includes a plan view and a bottom view of an antenna device included in the wristwatch 101. FIG. 2B is a cross-sectional view of a portion X-X in FIG. 2A.

FIG. 3 is an exploded perspective view of a feeding coil antenna 30.

FIG. 4 is a cross-sectional view of the feeding coil antenna 30.

FIG. 5 is a schematic view of a path of current flowing through a ground conductor 21 included in the antenna device of the wristwatch 101.

FIGS. 6A and 6B are schematic views of paths of current flowing through ground conductors 21 of antenna devices according to comparative examples.

FIG. 7 is a perspective view of a main portion of the communication terminal 102 according to a second preferred embodiment of the present invention.

FIG. 8 is a plan view of a circuit board 20 included in a communication terminal 102 according to the second preferred embodiment of the present invention.

FIG. 9 illustrates five positional relationships between an antenna device of an object to be measured, and an antenna device of a communication destination.

### DETAILED DESCRIPTION OF THE PREFERRED EMBODIMENTS

Preferred embodiments of the present invention will be described below with reference to the accompanying drawings.

### First Preferred Embodiment

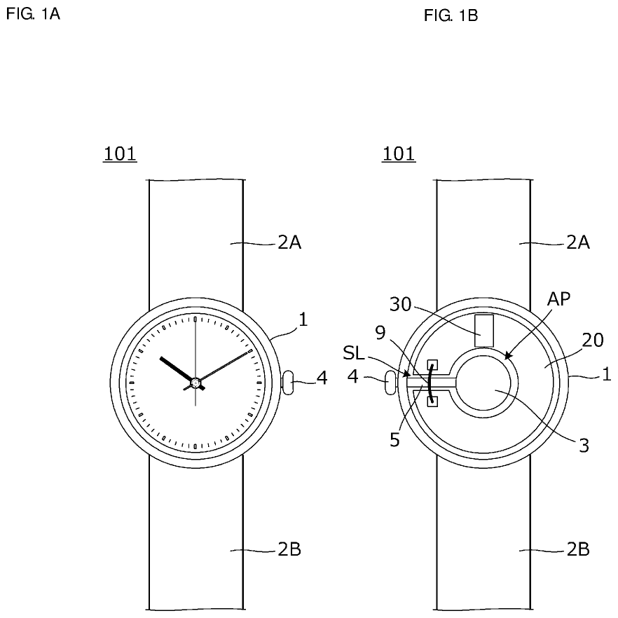

FIG. 1A is a plan view of a main portion of a wristwatch 101 according to a first preferred embodiment of the present invention, and FIG. 1B is a bottom view of the main portion. The wristwatch 101 is an example of a “stem-winding watch”. The wristwatch 101 includes an antenna device, a watch movement 3, a crown 4, a winding stem 5, which connects the watch movement 3 and the crown 4 to each other, a casing 1, and belts 2A and 2B attached to the casing 1. The casing 1 accommodates the antenna device, the watch movement 3, and the winding stem 5. The wristwatch 101 also corresponds to an example of a communication terminal according to preferred embodiments of the present invention. The watch movement 3 corresponds to an example of an “internal device”, the crown 4 corresponds to an example of an “external operator”, and the winding stem 5 corresponds to an example of an “operation stem”.

The antenna device includes a circuit board 20, a ground conductor provided in or on the circuit board 20, and a feeding coil antenna 30 mounted in or on the circuit board 20. The circuit board 20 corresponds to an example of a “substrate”, and the ground conductor corresponds to an example of a “planar conductor”.

The circuit board 20 includes an outer periphery, an opening AP, and a slit SL, which connects the inner periphery of the opening AP to the outer periphery. The winding stem 5 extends through the slit SL.

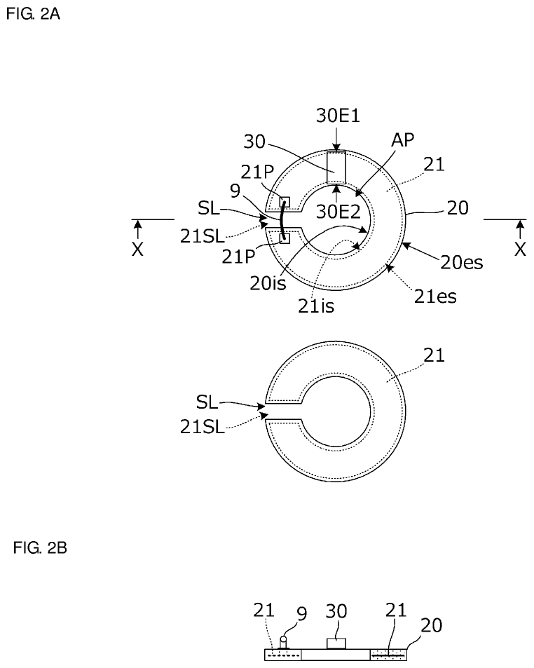

FIG. 2A includes a plan view and a bottom view of the antenna device included in the wristwatch 101. FIG. 2B is a cross-sectional view of a portion X-X in FIG. 2A. The circuit board 20 includes an outer periphery 20es, an opening AP, and a slit SL, which connects an inner periphery 20 is of the opening AP and the outer periphery 20es to each other. A ground conductor 21, having the same or substantially the same shape as the circuit board 20, is provided in or on the circuit board 20. Thus, the ground conductor 21 is preferably a C-shaped planar conductor including an outer periphery 21es, an opening AP, and a slit which connects an inner periphery 21is of the opening AP and the outer periphery 21es to each other. In other words, the circuit board 20 is preferably C-shaped the same as or similarly to the ground conductor 21.

The “C-shape” of the ground conductor 21 and the circuit board 20 may be referred to as a “discontinuous ring shape”.

In the present preferred embodiment, the “opening” AP defines and functions as an opening of the ground conductor 21 and an opening of the circuit board 20.

The feeding coil antenna 30 includes a first coil opening end 30E1 and a second coil opening end 30E2, which oppose each other. The feeding coil antenna 30 is mounted on the circuit board 20, and connected to a feeding circuit on the circuit board 20. The first coil opening end 30E1 of the feeding coil antenna 30 is adjacent to the outer periphery 21es of the ground conductor. Thus, the feeding coil antenna 30 is magnetically coupled with the ground conductor. The second coil opening end 30E2 is adjacent to the inner periphery 21is of the opening AP of the ground conductor 21. The minimum distance between the first coil opening end 30E1 and the outer periphery 21es of the ground conductor is preferably shorter than the minimum distance between the second coil opening end 30E2 and the outer periphery 21es of the ground conductor. The minimum distance between the second coil opening end 30E2 and the inner periphery 21is of the opening AP of the ground conductor is preferably shorter than the minimum distance between the first coil opening end 30E1 and the inner periphery 21is of the opening AP of the ground conductor 21. Specifically, the first coil opening end of the feeding coil antenna is adjacent to the outer periphery of the ground conductor. This positional relationship improves the magnetic coupling between the feeding coil antenna 30 and the ground conductor, and improves the function of the ground conductor as a booster antenna.

Although the circuit board 20 includes multiple electronic components in addition the feeding coil antenna 30 mounted thereon or therein, the drawings such as FIG. 1B and FIGS. 2A and 2B do not illustrate the other components for simplicity. The antenna device and the feeding circuit define a communication device. The communication device performs predetermined data communications with a communication destination device through, for example, near field communication (NFC).

Two connection conductor pads 21P, electrically connected to the ground conductor 21, are provided on or in the circuit board 20. A connection conductor 9 is connected to the connection conductor pads 21P. Specifically, the connection conductor 9 crosses a slit 21SL of the ground conductor 21 to connect portions of the ground conductor to each other. The connection conductor 9 defines a portion of a path of current flowing through the ground conductor 21 in a loop. The connection conductor 9 is preferably, for example, a covered wire including a conductor wire, such as a Cu wire, covered with an insulator film.

As illustrated in FIG. 1B, in a plan view, the watch movement 3 is disposed in the opening AP of the circuit board 20, and the winding stem 5 is disposed in the slit SL of the circuit board 20. The connection conductor 9, which is a covered wire, includes a first end connected to one of the two connection conductor pads 21P, a second end connected to the other one of the two connection conductor pads 21P, and a portion between the first end and the second end curved or bent to cross over the winding stem 5 in the slit SL. Specifically, the connection conductor 9 crosses over the winding stem 5 in the slit SL. The connection conductor 9, which is a covered wire covered with an insulator film, is not electrically connected to the winding stem 5 even when in contact with the winding stem 5. Thus, the connection conductor 9 is able to stabilize the antenna characteristics.

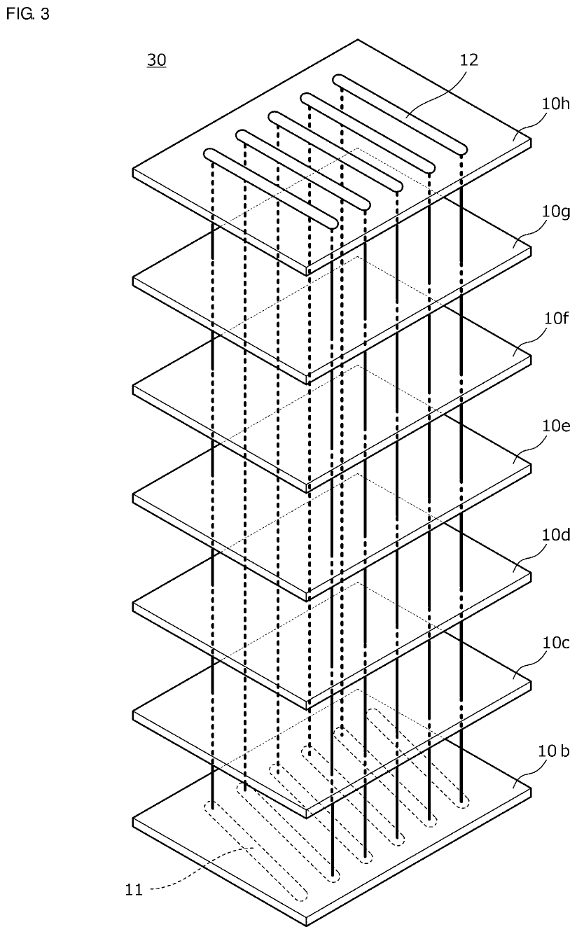

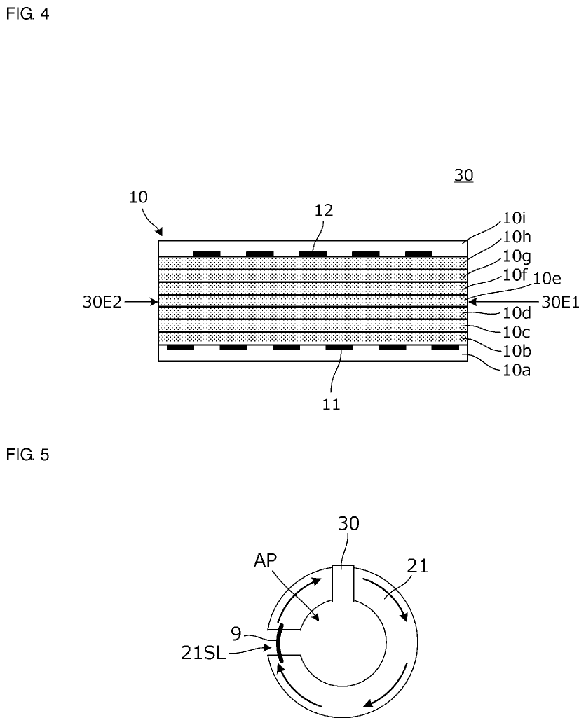

FIG. 3 is an exploded perspective view of the feeding coil antenna 30, and FIG. 4 is a cross-sectional view of the feeding coil antenna 30. The feeding coil antenna 30 includes a multi-layer substrate 10, defined by a laminate of multiple sheets 10a to 10i, and a coil conductor disposed in the multi-layer substrate 10. FIG. 3 does not illustrate the upper and lower non-magnetic sheets 10a and 10i. The magnetic sheet 10b includes multiple first strips 11 provided in or on a lower surface. The magnetic sheet 10h includes multiple second strips 12 provided in or on an upper surface. Multiple via conductors (interlayer connection conductors) are provided in the magnetic sheets 10b to 10h. The first strips 11, the second strips 12, and the via conductors define a coil conductor. Terminal electrodes connected to both ends of the coil conductor are provided on the lower surface of the non-magnetic sheet 10a. Thus, the feeding coil antenna 30 includes a helical coil conductor extending along a transverse flat angular tube.

FIG. 5 is a schematic view of a path of current flowing through the ground conductor 21 included in the antenna device of the wristwatch 101. FIG. 5 does not illustrate the circuit board 20. The feeding coil antenna 30 and the ground conductor 21 are electromagnetically coupled together. When current flows to the feeding coil antenna 30, current mainly circling along the peripheral portion of the ground conductor 21 is induced. Conversely, when current mainly circling along the peripheral portion of the ground conductor 21 flows, current is induced to the feeding coil antenna 30. When current mainly circling along the peripheral portion of the ground conductor 21 flows, the connection conductor 9 defines and functions as a portion of a current path.

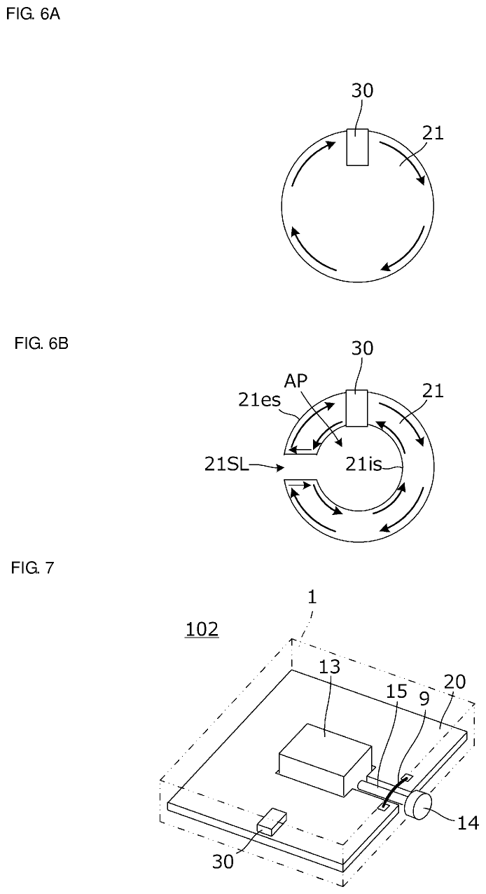

FIGS. 6A and 6B are schematic views of paths of current flowing through ground conductors 21 of antenna devices according to comparative examples. In the example illustrated in FIG. 6A, when current flows through a circular or substantially circular ground conductor 21, an induced current flows along the outer periphery of the ground conductor 21. In the example illustrated in FIG. 6B, when current flows through a C-shaped ground conductor 21, an induced current flows along the outer periphery of the ground conductor 21, the inner periphery of the opening AP, and both peripheries of the slit 21SL. The circulation direction of current flowing along the outer periphery 21es of the ground conductor 21 is opposite to the circulation direction of current flowing along the inner periphery 21is of the opening AP. Thus, the ground conductor 21 does not effectively define and function as a booster antenna.

In contrast, as illustrated in FIG. 5, when the slit 21SL of the ground conductor 21 is bridged by the connection conductor 9, a portion of the current flowing through the ground conductor 21 that is to flow through the slit 21SL crosses the connection conductor 9, crossing the slit 21SL, so that almost no current flows along the slit 21SL and the inner periphery of the opening AP. The ground conductor 21 thus equivalently includes neither an opening AP nor a slit 21SL, so that the ground conductor 21 effectively defines and functions as a booster antenna, as in the case of the comparative example illustrated in FIG. 6A. Here, with the cut-edge effect, the strength distribution of the current flowing through the ground conductor 21 peaks along the outer periphery of the ground conductor 21. Thus, the connection conductor 9 is preferably disposed at a portion of the slit 21SL as close to the outer side of the ground conductor 21 as possible.

The differences in characteristics between antenna devices with and without a connection conductor according to the present preferred embodiment is described.

Table 1 shows the NFC characteristics of the antenna device according to the present preferred embodiment. In Table 1, three parameters in parentheses show positional relationships between an antenna device (antenna device according to the present preferred embodiment) that is to be measured, and an antenna device defining and functioning as a communication destination. The figures in Table 1 are represented in units of mV.

The three parameters in parentheses are denoted with (z, r, φ), which represent the followings.

z: gap in vertical direction

r: gap in horizontal direction

Φ: azimuth of r

z=0: about 0 mm

z=1: about 1 mm

z=2: about 2 mm

z=3: about 3 mm

z=4: about 4 mm

r=0: about 0 mm

r=1: about 15 mm

φ=0: 12 o'clock direction

φ=3: 3 o'clock direction

φ=6: 6 o'clock direction

φ=9: 9 o'clock direction

FIG. 9 illustrates the positional relationships of these devices for the cases of (z, 0, 0), (z, 1, 0), (z, 1, 3), (z, 1, 6), and (z, 1, 9).

TABLE 1

| | |
|---|---|
| Type A | Type B |

(A)

| | | |
|---|---|---|
| (0, 0, 0) | 26.3 | 25.8 |
| (0, 1, 0) | 24.4 | 23.2 |
| (0, 1, 3) | 23.0 | 21.2 |
| (0, 1, 6) | 23.1 | 21.8 |
| (0, 1, 9) | 24.3 | 23.5 |
| (1, 0, 0) | 19.0 | 16.0 |
| (1, 1, 0) | 16.8 | 14.0 |
| (1, 1, 3) | 15.5 | 13.2 |
| (1, 1, 6) | 15.8 | 14.1 |
| (1, 1, 9) | 16.6 | 14.9 |
| (2, 0, 0) | 11.7 | 10.4 |
| (2, 1, 0) | 10.3 | 9.1 |
| (2, 1, 3) | 10.0 | 8.5 |
| (2, 1, 6) | 10.7 | 8.9 |
| (2, 1, 9) | 10.7 | 9.2 |
| (3, 0, 0) | 8.1 | 6.7 |
| (3, 1, 0) | 7.0 | 6.1 |
| (3, 1, 3) | 6.4 | 5.4 |
| (3, 1, 6) | 6.6 | 5.9 |
| (3, 1, 9) | 7.0 | 6.3 |
| (4, 0, 0) | 5.4 | 4.9 |
| (4, 1, 0) | 3.9 | 4.2 |
| (4, 1, 3) | 4.3 | 4.3 |
| (4, 1, 6) | 4.6 | 4.2 |
| (4, 1, 9) | 4.7 | 4.5 |

(B)

| | | |
|---|---|---|
| (0, 0, 0) | 18.2 | 17.1 |
| (0, 1, 0) | 17.3 | 17.0 |
| (0, 1, 3) | 15.6 | 14.8 |
| (0, 1, 6) | 14.6 | 14.1 |
| (0, 1, 9) | 16.1 | 15.7 |
| (1, 0, 0) | 12.3 | 11.1 |
| (1, 1, 0) | 10.7 | 10.1 |
| (1, 1, 3) | 10.5 | 9.2 |
| (1, 1, 6) | 10.0 | 9.0 |
| (1, 1, 9) | 10.5 | 9.8 |
| (2, 0, 0) | 7.9 | 7.1 |
| (2, 1, 0) | 6.7 | 6.3 |
| (2, 1, 3) | 6.7 | 5.7 |
| (2, 1, 6) | 6.7 | 5.7 |
| (2, 1, 9) | 6.7 | 6.0 |
| (3, 0, 0) | 5.0 | 4.3 |
| (3, 1, 0) | 4.1 | 4.1 |
| (3, 1, 3) | 4.3 | 3.6 |
| (3, 1, 6) | 3.3 | 3.7 |
| (3, 1, 9) | 4.6 | 3.9 |
| (4, 0, 0) | 3.3 | 3.0 |
| (4, 1, 0) | 0.8* | 0.9* |
| (4, 1, 3) | 1.0* | 0.7* |
| (4, 1, 6) | 1.0* | 0.9* |
| (4, 1, 9) | 0.9* | 0.8* |

In Table 1, type (A) represents the characteristics of the antenna device according to the present preferred embodiment, and type (B) represents the characteristics of an antenna device according to a comparative example, not including the connection conductor 9.

In Table 1, the figures identified by asterisks are smaller than or equal to about 1.0, which fail to satisfy the required values. In the antenna device according to the present preferred embodiment, the figures exceed about 1.0 in all sets of conditions, so that the gain is understood as being enhanced.

### Second Preferred Embodiment

A second preferred embodiment of the present invention describes an example of a communication terminal other than a wristwatch.

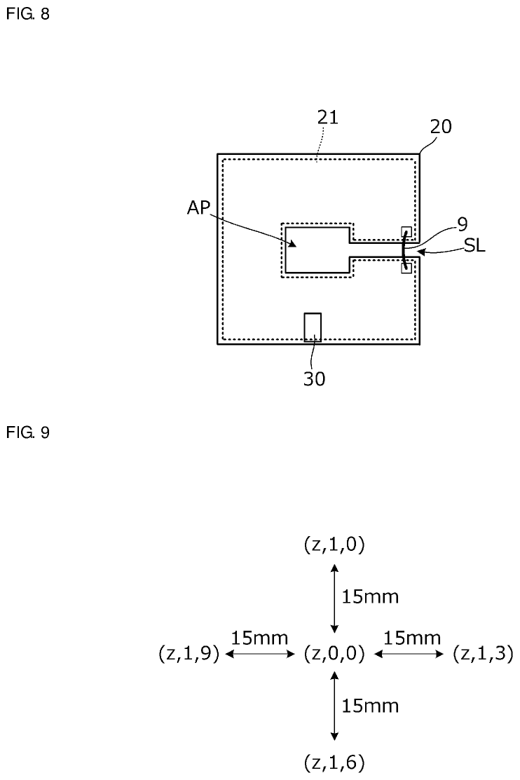

FIG. 7 is a perspective view of a main portion of a communication terminal 102 according to the second preferred embodiment. FIG. 8 is a plan view of a circuit board 20 included in the communication terminal 102. FIG. 8 illustrates the feeding coil antenna 30 and the connection conductor 9 together with the circuit board 20. FIG. 7 illustrates the profile of the casing 1 with two-dot chain lines.

The communication terminal 102 according to the present preferred embodiment includes an antenna device, an internal device 13, an external operator 14, an operation stem 15 connecting the internal device 13 and the external operator 14 to each other, and a casing 1 accommodating the antenna device, the internal device 13, and the operation stem 15.

The antenna device includes a circuit board 20, a ground conductor 21, provided in or on the circuit board 20, and a feeding coil antenna 30, mounted on or in the circuit board 20. The circuit board 20 corresponds to an example of a “substrate”, and the ground conductor corresponds to an example of a “planar conductor”.

The circuit board 20 includes an outer periphery, an opening AP, and a slit SL, which connects the inner periphery of the opening AP and the outer periphery to each other. The operation stem 15 extends through the slit SL.

The basic structure of the present preferred embodiment is the same or substantially the same as that of the wristwatch according to the first preferred embodiment, except that the internal device 13 preferably has a flat rectangular or substantially rectangular shape, the opening AP accordingly preferably has a rectangular or substantially rectangular shape, and the circuit board 20 preferably has a rectangular or substantially rectangular profile, for example.

In each preferred embodiment of the present invention, a ground conductor provided in or on the circuit board has been described as an example of a “planar conductor”. However, a “planar conductor” according to preferred embodiments of the present invention is not limited to the ground conductor, and may be a flat conductor extending in or on any substrate.

The slits SL and 21SL described in the preferred embodiments are examples of a “cut portion”. The “cut portion” may have a shape such that opposing portions of the planar conductor across a gap may be not parallel or substantially parallel to each other.

Each preferred embodiment has described a case in which the slit SL or 21SL has a width in the gap direction smaller than the width of the opening AP. However, the slit SL or 21SL may have a width equal or substantially equal to the width of the opening AP. Specifically, the slit and the opening may be integrated or substantially integrated together.

Each preferred embodiment has described a case in which a single connection conductor 9 is used. However, multiple connection conductors may be included to connect portions of the planar conductor to each other. Instead of a covered wire including a conductor wire, such as a Cu wire, covered with an insulator film, the connection conductor may be a conductor pattern provided on or in a flexible printed circuit (FPC), as long as it defines and functions as a portion of a path of current flowing through the ground conductor 21 in a loop.

Each preferred embodiment has described a case in which a “slit” is provided at a single portion of the planar conductor. However, preferred embodiments of the present invention are also applicable to a device that includes multiple crowns, winding stems, external operators, and operation stems. Specifically, connection conductors that each connect portions of the planar conductor to each other may be disposed at multiple cut portions at different positions.

Each preferred embodiment has described a case in which the planar conductor has a circular, substantially circular, rectangular, or substantially rectangular outer periphery. However, the planar conductor may have an outer periphery of an irregular shape. The same holds true for the shape of the opening.

Each preferred embodiment has described a case in which the planar conductor has a flat shape. However, the planar conductor may have a curved shape or may have a partially curved surface.

The first preferred embodiment has described a wristwatch. However, preferred embodiments of the present invention are similarly applicable to other stem-winding watches, such as a pocket watch or a stopwatch.

Each preferred embodiment has mainly described an antenna device and an electronic device for a communication system utilizing magnetic coupling, such as NFC. However, each preferred embodiment is similarly applicable to a contactless power transfer system (such as electromagnetic induction or magnetic resonance) utilizing magnetic coupling. For example, an antenna device according to each preferred embodiment is usable as a power receiving antenna device in a power receiving device of a magnetic-resonance contactless power transfer system usable for a high frequency (HF) range, particularly, frequencies at or around 6.78 MHz. Also in this case, the antenna device defines and functions as a power receiving antenna device. In the contactless power transfer system, the “feeding circuit” described in the above preferred embodiment corresponds to a power receiving circuit or a power transfer circuit. In the case of a power receiving circuit, the antenna device is connected to the power receiving antenna device to feed power to the load (such as a secondary cell). In the case of a power transfer circuit, the antenna device is connected to a power transfer antenna device to feed power to the power transfer antenna device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna device, comprising:
a planar conductor;
a substrate in or on which the planar conductor is disposed, the substrate having an identical or substantially identical shape as the planar conductor;
a feeding coil antenna including a first coil opening end and a second coil opening end, which oppose each other, the feeding coil antenna being mounted on or in the substrate; and
a connection conductor; wherein
the planar conductor includes:
an outer periphery;
an opening;
an inner periphery defined by the opening; and
a cut portion that connects the inner periphery and the outer periphery to each other;
the connection conductor crosses the cut portion of the planar conductor to connect portions of the planar conductor to each other, and defines a portion of a path of current flowing through the planar conductor in a loop; and
the first coil opening end of the feeding coil antenna is located closer to the outer periphery of the planar conductor than to the inner periphery of the opening of the planar conductor.

2. The antenna device according to claim 1, wherein the connection conductor is a covered wire including a conductor wire covered with an insulator film.

3. The antenna device according to claim 2, wherein the conductor wire is made of Cu.

4. The antenna device according to claim 1, wherein the planar conductor has a C-shape.

5. The antenna device according to claim 1, wherein the substrate has a C-shape.

6. The antenna device according to claim 1, wherein the feeding coil antenna includes a multi-layer substrate including a laminate of multiple sheets, and a coil conductor disposed in the multi-layer substrate.

7. A communication terminal, comprising:
an antenna device;
an internal device;
an external operator; and
an operation stem that connects the internal device and the external operator to each other; wherein
the antenna device includes:
a planar conductor;
a substrate in or on which the planar conductor is disposed, the substrate having an identical or substantially identical shape as the planar conductor;
a feeding coil antenna including a first coil opening end and a second coil opening end, which oppose each other, the feeding coil antenna being mounted on or in the substrate; and
a connection conductor;
the planar conductor includes:
an outer periphery;
an opening;
an inner periphery defined by the opening; and
a cut portion that connects the inner periphery and the outer periphery to each other;
the connection conductor crosses the cut portion of the planar conductor to connect portions of the planar conductor to each other, and defines a portion of a path of current flowing through the planar conductor in a loop; and
the first coil opening end of the feeding coil antenna is located closer to the outer periphery of the planar conductor than to the inner periphery of the opening of the planar conductor.

8. The communication terminal according to claim 7, wherein the connection conductor is a covered wire including a conductor wire covered with an insulator film.

9. The communication terminal according to claim 8, wherein the conductor wire is made of Cu.

10. The communication terminal according to claim 7, wherein the planar conductor has a C-shape.

11. The communication terminal according to claim 7, wherein the substrate has a C-shape.

12. The communication terminal according to claim 7, wherein the feeding coil antenna includes a multi-layer substrate including a laminate of multiple sheets, and a coil conductor disposed in the multi-layer substrate.

13. A stem-winding watch, comprising:
an antenna device;
a watch movement;
a crown;
a winding stem that connects the watch movement and the crown to each other; and
a casing that accommodates the antenna device, the watch movement, and the winding stem; wherein
the antenna device includes:
a planar conductor;
a substrate in or on which the planar conductor is disposed, the substrate having an identical or substantially identical shape as the planar conductor;
a feeding coil antenna including a first coil opening end and a second coil opening end, which oppose each other, the feeding coil antenna being mounted on or in the substrate; and
a connection conductor;
the planar conductor includes:
an outer periphery;
an opening;
an inner periphery defined by the opening; and
a cut portion that connects the inner periphery and the outer periphery to each other;
the connection conductor crosses the cut portion of the planar conductor to connect portions of the planar conductor to each other, and defines a portion of a path of current flowing through the planar conductor in a loop; and
the first coil opening end of the feeding coil antenna is located closer to the outer periphery of the planar conductor than to the inner periphery of the opening of the planar conductor.

14. The stem-winding watch according to claim 13, wherein
the substrate includes a slit corresponding to the cut portion; and
when viewed in a plan view, the watch movement is disposed in the opening, and the winding stem is disposed in the slit.

15. The stem-winding watch according to claim 14, wherein the connection conductor crosses over the winding stem in the slit.

16. The stem-winding watch according to claim 13, wherein the connection conductor is a covered wire including a conductor wire covered with an insulator film.

17. The stem-winding watch according to claim 16, wherein the conductor wire is made of Cu.

18. The stem-winding watch according to claim 13, wherein the planar conductor has a C-shape.

19. The stem-winding watch according to claim 13, wherein the substrate has a C-shape.

20. The stem-winding watch according to claim 13, wherein the feeding coil antenna includes a multi-layer substrate including a laminate of multiple sheets, and a coil conductor disposed in the multi-layer substrate.
